(19) United States
(12) Patent Application Publication
(10) Pub. No.: US 2020/0357560 A1
(43) Pub. Date: Nov. 12, 2020

(54) INDUCTIVE ASSEMBLY

(71) Applicant: Lear Corporation, Southfield, MI (US)

(72) Inventors: Enric APARICIO ROLLAN, Valls (ES); Jose Antonio CUBERO PITEL, Valls (ES); Vasile GICA, Valls (ES); Ramon SANCHEZ ROVIRA, Valls (ES)

(21) Appl. No.: 16/406,173

(22) Filed: May 8, 2019

(51) Int. Cl. H01F 27/08; H01F 27/06; H01F 27/29; H01F 41/02

(52) U.S. Cl. CPC H01F 27/08; H01F 41/02; H01F 27/29; H01F 27/06

(57) ABSTRACT

An inductive assembly is provided with a heat exchanger and an inductor. A thermally conductive adhesive is disposed upon a surface of the inductor and bonded to the heat exchanger to transfer heat from the inductor to the heat exchanger. An inductive coil assembly is provided with a frame. A post is connected to the frame. At least one inductive coil is installed upon the post. A thermally conductive coating is disposed over the at least one inductive coil.

### TECHNICAL FIELD

Various embodiments relate to inductive assemblies for automotive applications.

### BACKGROUND

Inductive coil assemblies are employed in automotive inductive applications such as transformers, filters, chargers and converters. Inductive assemblies are provided with inductors, which are components of an electrical assembly that act upon another or are acted upon themselves by induction. Inductors often include coils and cores. Inductive coil assemblies are assembled within a frame and a thermally conductive material is molded into the frame.

### SUMMARY

According to at least one embodiment, an inductive assembly is provided with a frame. A locating member is connected to the frame. At least one inductor is installed to the locating member. A thermally conductive coating is disposed over the at least one inductor.

According to a further embodiment, the thermally conductive coating is disposed over at least a portion of the frame.

According to another further embodiment, a receptacle is formed through the frame. At least one conductive terminal is in electrical communication with the at least one inductor. The at least one conductive terminal extends through the receptacle.

According to another further embodiment, thermally conductive adhesive is disposed across one surface of the thermally conductive coating.

According to an even further embodiment, a heat exchanger is provided. The thermally conductive adhesive adheres the thermally conductive coating to the heat exchanger to transfer heat from the at least one inductor to the heat exchanger through the thermally conductive coating and the thermally conductive adhesive.

According to another further embodiment, the inductive assembly is not formed with any fastener apertures to mechanically fasten the inductive assembly to another component.

According to another further embodiment, the locating member further provides a plurality of locating members connected to the frame. The at least one inductor further provides a plurality of inductors, each installed to one of the plurality of locating members.

According to an even further embodiment, the thermally conductive coating is disposed over the plurality of inductors.

According to another even further embodiment, a heat exchanger is provided. A thermally conductive adhesive adheres the thermally conductive coating to the heat exchanger to transfer heat from the plurality of inductors to the heat exchanger through the thermally conductive coating and the thermally conductive adhesive.

According to another even further embodiment, a plurality of receptacles is formed through the frame. Each of the plurality of inductors further includes at least one conductive terminal in electrical communication with the corresponding inductor. The at least one conductive terminal extends through one of the plurality of receptacles.

According to another further embodiment, the at least one inductor is further provided as at least one inductive coil.

According to an even further embodiment, the locating member is further provided as a post sized to receive the at least one inductive coil.

According to another even further embodiment, an external surface of the thermally conductive coating is generally cylindrical or frusto-conical.

According to another embodiment, an inductive assembly is provided with a heat exchanger and an inductor. A thermally conductive adhesive is disposed upon a surface of the inductor and bonded to the heat exchanger to transfer heat from the inductor to the heat exchanger.

According to another embodiment, a method for manufacturing an inductive assembly, provides an inductor. A thermally conductive adhesive is adhered upon a surface of the inductor.

According to a further embodiment, the inductor is adhered to a heat exchanger with the thermally conductive adhesive.

According to another further embodiment, the inductor is assembled to a heat exchanger without any mechanical fasteners.

According to another further embodiment, the frame is provided with a locating member. An inductive coil is installed to the locating member.

According to an even further embodiment, a thermally conductive coating is molded over the inductive coil and at least a portion of the frame.

According to another even further embodiment, the thermally conductive coating provides the surface with the thermally conductive adhesive adhered thereupon.

### BRIEF DESCRIPTION OF THE DRAWINGS

FIG. 1 is a front perspective view of a vehicle inductive assembly according to an embodiment illustrated in cooperation with a heat exchanger;

FIG. 2 is an exploded perspective view of the vehicle inductive assembly of FIG. 1;

FIG. 3 is a bottom perspective view of the vehicle inductive assembly of FIG. 1, illustrated partially assembled;

FIG. 4 is another bottom perspective view of the vehicle inductive assembly of FIG. 1;

FIG. 5 is a schematic illustration of the vehicle inductive assembly of FIG. 1 depicting thermal ranges of the vehicle inductive assembly under ordinary operating conditions;

FIG. 6 is another schematic illustration of the vehicle inductive assembly of FIG. 1, illustrated partially disassembled and depicting thermal ranges of the vehicle transformer assembly under ordinary operating conditions;

FIG. 7 is a front perspective view of a vehicle inductive assembly according to another embodiment illustrated partially disassembled;

FIG. 8 is an enlarged front perspective view of the inductive assembly illustrated further disassemble and in cooperation with a heat exchanger; and

FIG. 9 is a section view of the inductive assembly of FIG. 7 taken along section line 9-9.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Automotive inductive assemblies include electromagnetic transformers, filters, and the like, for high voltage and/or high current applications. Such applications include vehicle on-board chargers and converters. These applications often generate significant heat that is dissipated within the vehicle environment. The prior art has provided heat exchangers, often referred to as cooling plates, in contact with the transformers to conduct the heat away from the transformers. The cooling plates are often liquid cooled.

The prior art has employed magnetic toroidal inductive coils in inductive assemblies. Multiple coils have been utilized, such as three coils for three phase charging. A plastic frame has been employed with a bottom and perimeter sidewalls to define a cavity therein. The magnetic coils are placed within the frame. The frame holds the magnetic coils in place and permits attachment of connection terminals to the frame for electrical connection to the coils.

Once in place within the frame, a thermally conductive material, known as potting, is cast into the frame about the magnetic coils. The potting encloses the coils and maintains the coils within position in the external frame. The potting also facilitates heat transfer from the coils and out of the frame.

The frame is fastened to the cooling plate, thereby requiring additional metal elements, such as screws. The screws add cost in materials and assembling processes. Plus, the screw holes in the heat exchanger require bosses or towers within a cooling cavity to receive the screws. The frame and the potting are not flush within appropriate tolerances, so a thermally conductive paste is provided between the frame and the cooling plate to address the tolerance gaps. Additionally, the plastic frame provides an additional insulator about the magnetic coils, which require cooling.

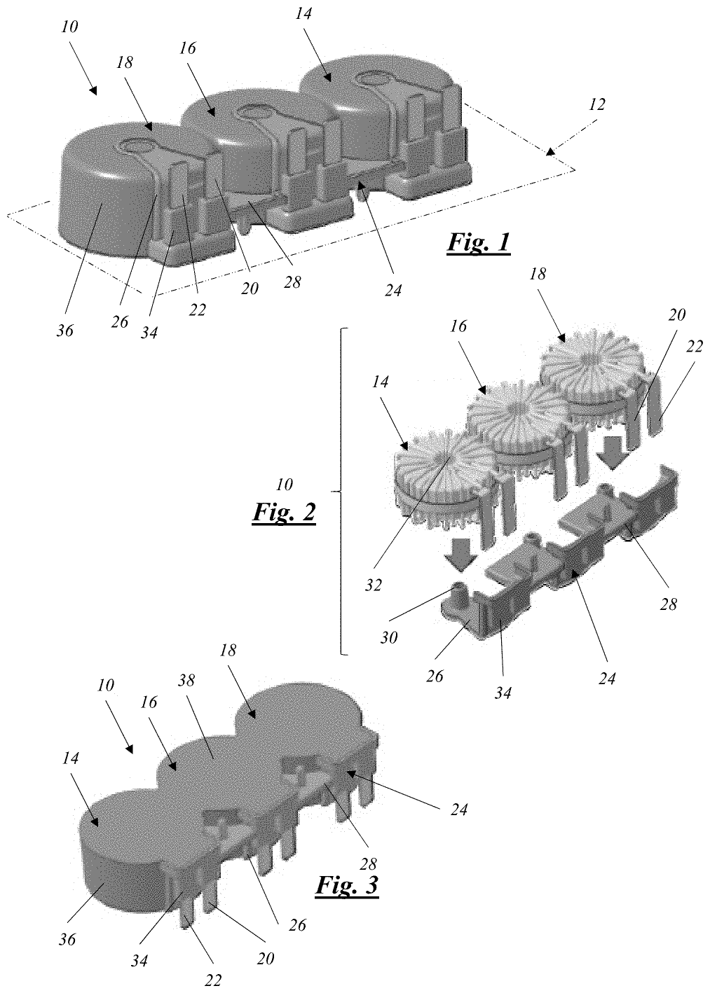

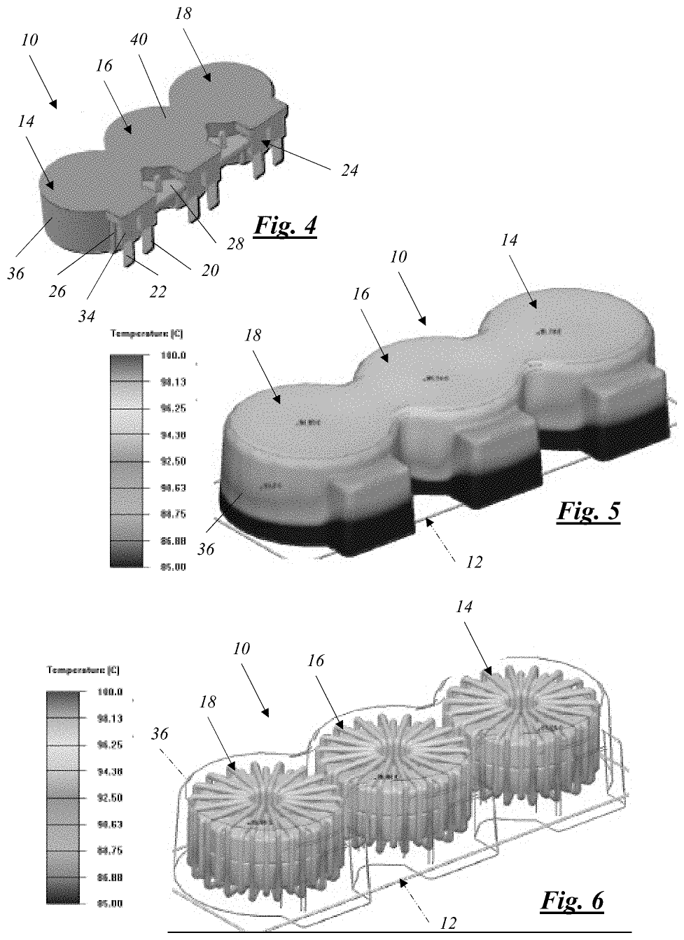

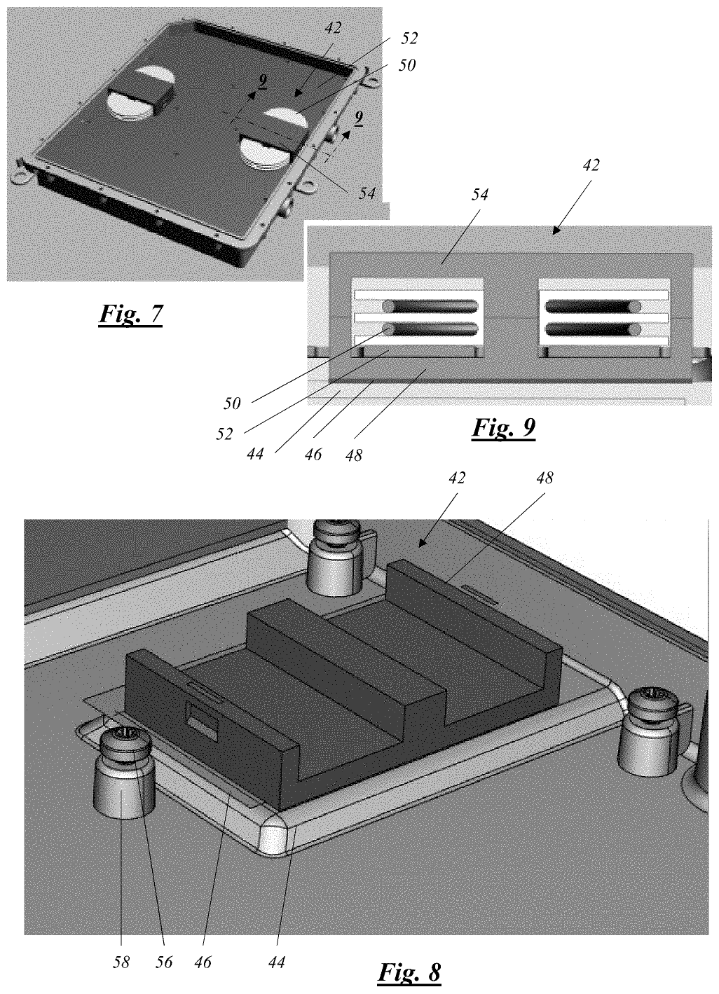

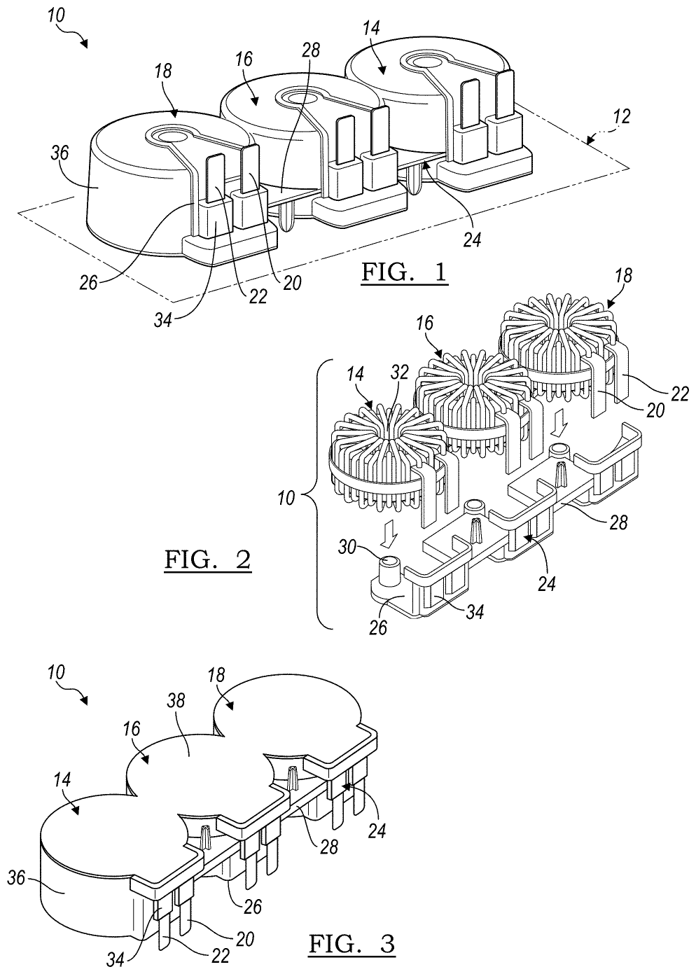

With reference now to FIG. 1, an inductive assembly, such as an inductive coil assembly 10 is illustrated upon a cooling plate 12. The cooling plate 12 may be liquid cooled with fluid pumped into the cooling plate 12 to receive heat transferred from the coil assembly 10 into the cooling plate 12. The heated fluid is successively pumped out of the cooling plate 12 to distribute the heat at another location within the vehicle environment.

In comparison to the prior art, the inductive coil assembly 10 minimizes the plastic frame and reduces the use of thermally conductive paste. Additionally, the inductive coil assembly 10 utilizes adhesive to adhere the inductive coil assembly 10 directly to the cooling plate 12, thereby omitting fasteners, and associated apertures in bosses or towers, manufacturing costs and materials expenses.

Referring now to FIG. 2, the inductive coil assembly 10 is illustrated partially disassembled. The inductive coil assembly 10 include three inductors as inductive coils 14, 16, 18. Of course, any quantity, layout, and/or disposition of coils may be employed. Three inductive coils 14, 16, 18 are useful for three phase charging. Each inductive coil 14, 16, 18 has a pair of conductive terminals 20, 22 each in electrical communication with the corresponding inductive coil 14, 16, 18 to transfer electrical power through the inductive coil 14, 16, 18.

Referring now to FIGS. 1-4, the inductive coil assembly 10 includes a frame 24 for positioning the inductive coils 14, 16, 18. The frame 24 includes a plurality of brackets 26, each for supporting one of the inductive coils 14, 16, 18. The brackets are angled to extend across two surfaces, such as the top and a portion of a lateral side, of the inductive coils 14, 16, 18. The brackets 26 are spaced apart and are interconnected by cross members 28 of the frame 24.

Referring now to FIG. 2, a post 30 is provided on each bracket 26 of the frame 24. Each inductive coil 14, 16, 18 has a central aperture 32 that is received upon one of the posts 30. The posts 30 accurately position the inductive coils 14, 16, 18. The posts 30 may be also be sized for an interference fit within the coil apertures 32 to provide some preliminary fixation of the inductive coils 14, 16, 18 to the frame 24.

Referring again to FIGS. 1-4, a receptacle 34 is provided on each bracket 26 of the frame 24. The receptacles 34 permit the terminals 20, 22 to pass through the frame 24. After assembly of the inductive coils 14, 16, 18 to the frame 24, the inductive coils 14, 16, 18 are installed upon the posts 30 and the terminals 20, 22 are oriented external of the frame 24.

Next, the assembled coils 14, 16, 18 and the frame 24 are placed in a mold, and a thermally conductive potting material 36 is molded about the inductive coils 14, 16, 18 and partially about the brackets 26 of the frame 24. The potting 36 secures the inductive coils 14, 16, 18 to the frame 24. The potting 36 takes a shape that is nearly cylindrical to match the shape of the coils 14, 16, 18, however, with a taper associated with a draft angle of the mold. Therefore, the shape of the coils 14, 16, 18 are frusto-conical with a minimum draft angle for removal from the mold. Any suitable thermally conductive potting 36 may be employed. Suitable examples include HumiSeal® Thermosink 35-3 and DOWSUK™ TC-6020.

In this application, the coils 14, 16, 18 are made on a toroid core. The potting material 36 is also shaped to provide a bottom planar surface 38 for optimal thermal contact, and thus, thermal transfer with the cooling plate 12. Although the bottom surface 38 of the potting 36 is in contact with the cooling plate 12, any suitable surface of the inductive assembly 10, such as a core, may be bonded in contact with the cooling plate 12.

The frame 24 is formed from a structural plastic with insulative properties. Unlike the prior art, the frame 24 does not enclose the inductive coils 14, 16, 18. The frame 24 is minimized to optimize heat transfer from the inductive coils 14, 16, 18 to the cooling plate 12. Also, the size and costs of the of the inductive coil assembly 10 are minimized by reducing the frame 24 and the reducing potting material 36.

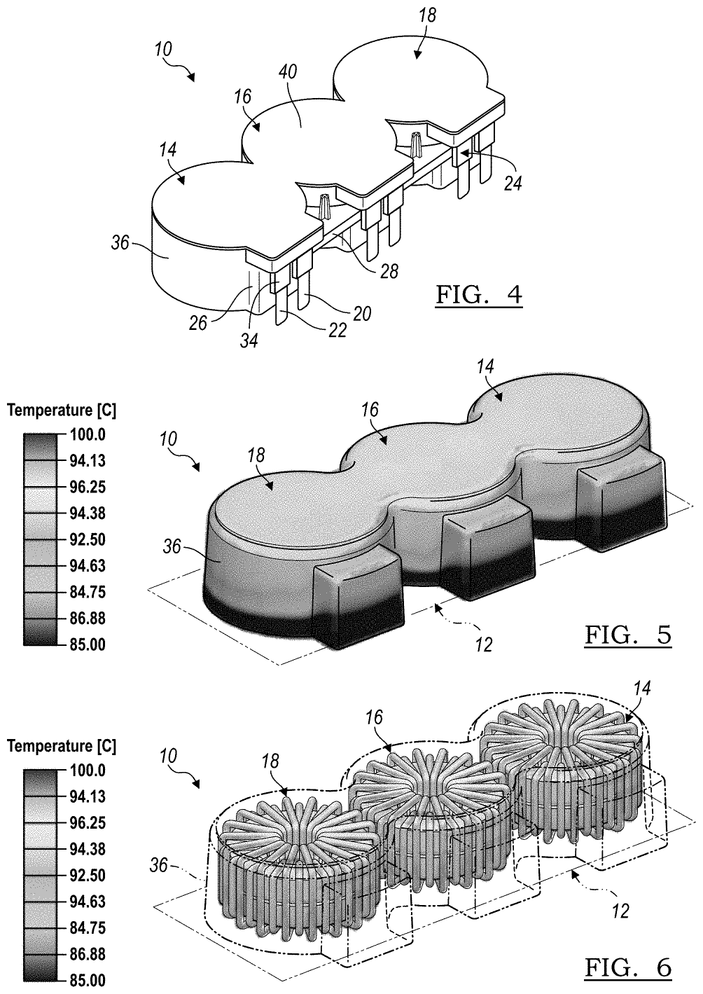

Referring to FIG. 3, the potting 36 is the primary material at the bottom contact surface 38 of the inductive coil assembly 10. The uniformity of the contact surface 38 minimizes tolerances to improve contact with the cooling plate 12. Referring now to FIG. 4, a thermally conductive adhesive 40 is applied upon the contact surface 38. The thermally conductive adhesive 40 adheres the inductive coil assembly 10 directly to the cooling plate 12. Therefore, as power is conveyed through the inductive coils 14, 16, 18, generated heat is conducted from the coils 14, 16, 18, through the potting 36 and adhesive 40 to the cooling plate 12. By utilizing the adhesive 40, additional mechanical fasteners are omitted, thereby eliminating fastener apertures in the inductive coil assembly 10 and eliminating fastener aperture towers within the cooling plate 12. Any suitable thermally conductive adhesive may be employed. Suitable examples include Henkel Corporation LBEA1805 and DOWSIL™ 1-4174. Some centering posts (with minimum hole depth) may be designed in the plastic frame 24 or generated by the potting 36, to facilitate the inductive coil assembly 10 to an accurate location in the cooling surface 12 before the adhesive 40 is cured.

FIGS. 5 and 6 schematically depict a thermal map for the inductive coil assembly 10 under ordinary operating conditions. The thermal map demonstrates optimal heat flow to the cooling plate 12. Peak temperature measurements include under ninety-seven degrees Celsius (C) at the inductive coils 14, 16, 18, and under ninety-six degrees C. at the potting 36. In contrast, under the same operating conditions, the prior art inductive coil assemblies have peak temperature measurements of over 115 degrees C. at one of the inductive coils, and up to 114 degrees C. at the potting. Therefore, the inductive coil assembly 10 improves heat transfer, reduces a peak operating temperature, eliminates mechanical fasteners, reduces components, reduces cost, reduces the weight of the frame 24, eliminates fastener apertures in the frame 24, removes fastener apertures and towers in the cooling plate 12, and shortens manufacturing time and processes.

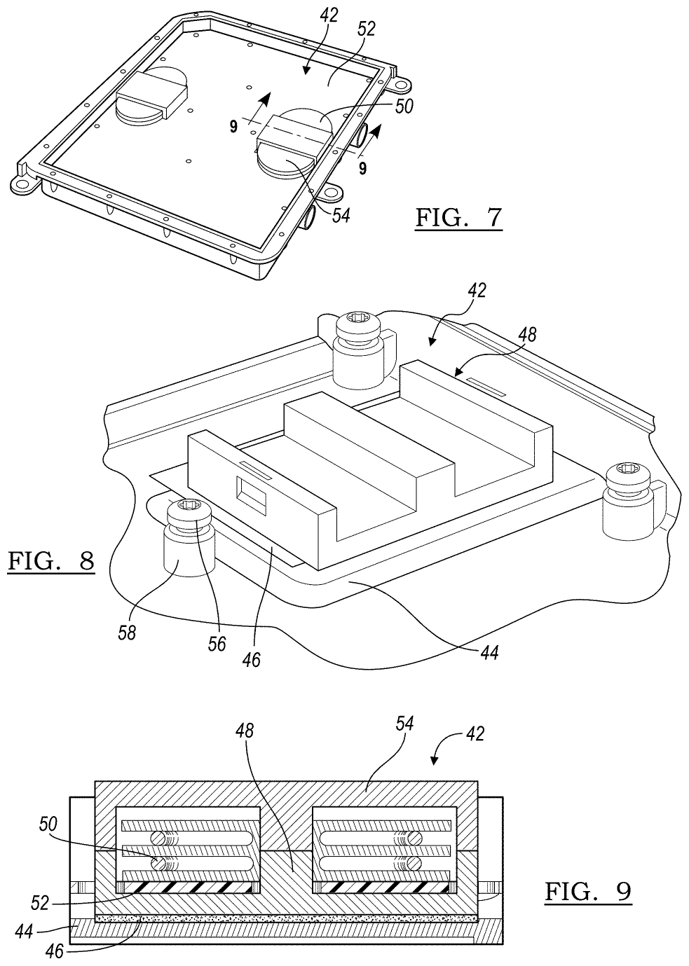

FIGS. 7-9 illustrate a partially disassembled inductive assembly 42 according to another embodiment. The inductive assembly 42 is fastened directly to a cooling plate 44 (FIGS. 8 and 9) without mechanical fasteners. Instead a thermally conductive adhesive 46 is applied between the inductive assembly 42 and the cooling plate 44. A ferrite-core half 48, that is part of the inductive assembly 42, is illustrated adhered to the cooling plate 44. The inductive assembly 42 includes an inductive coil 50 as part of an electronic printed circuit board (PCB) 52 (FIGS. 7 and 9). The electronic circuit (PCB 52 with the coil 50) is placed on top of the ferrite-core half 48. Subsequently, a second ferrite-core half 54 (FIGS. 7 and 9) is glued to the first ferrite-core half 48. The PCB 52 is fastened directly to the cooling plate 44 by screws 56 at fastener towers 58 to ensure core fixation to the cooling plate 44 against system vibrations. However, the fastener towers 58 are outside of an underlying cooling path, and therefore do not interfere with the thermal transfer path and dissipation. The screws 56 affix the PCB assembly and soldered components in place and minimize PCB 58 vibration. The core half 48 is fixed to the cooling plate 44 with the adhesive 46, not by the screws 50.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An inductive assembly comprising:
a frame;
a locating member connected to the frame;
at least one inductor installed to the locating member; and
a thermally conductive coating disposed over the at least one inductor.

2. The inductive assembly of claim 1 wherein the thermally conductive coating is disposed over at least a portion of the frame.

3. The inductive assembly of claim 1 wherein a receptacle is formed through the frame; and
wherein the inductive assembly further comprises at least one conductive terminal in electrical communication with the at least one inductor, the at least one conductive terminal extending through the receptacle.

4. The inductive assembly of claim 1 further comprising thermally conductive adhesive disposed across one surface of the thermally conductive coating.

5. The inductive assembly of claim 4 further comprising a heat exchanger, wherein the thermally conductive adhesive adheres the thermally conductive coating to the heat exchanger to transfer heat from the at least one inductor to the heat exchanger through the thermally conductive coating and the thermally conductive adhesive.

6. The inductive assembly of claim 1 wherein the inductive assembly is not formed with any fastener apertures to mechanically fasten the inductive assembly to another component.

7. The inductive assembly of claim 1 wherein the locating member further comprises a plurality of locating members connected to the frame; and
wherein the at least one inductor further comprises a plurality of inductors, each installed to one of the plurality of locating members.

8. The inductive assembly of claim 7 wherein the thermally conductive coating is disposed over the plurality of inductors.

9. The inductive assembly of claim 8 further comprising:
a heat exchanger; and
a thermally conductive adhesive adhering the thermally conductive coating to the heat exchanger to transfer heat from the plurality of inductors to the heat exchanger through the thermally conductive coating and the thermally conductive adhesive.

10. The inductive assembly of claim 7 wherein a plurality of receptacles is formed through the frame; and
wherein each of the plurality of inductors, further comprises at least one conductive terminal in electrical communication with the corresponding inductor, the at least one conductive terminal extending through one of the plurality of receptacles.

11. The inductive assembly of claim 1 wherein the at least one inductor further comprises at least one inductive coil.

12. The inductive assembly of claim 11 wherein the locating member further comprises a post sized to receive the at least one inductive coil.

13. The transformer assembly of claim 11 wherein an external surface of the thermally conductive coating is generally cylindrical or frusto-conical.

14. An inductive assembly comprising:
a heat exchanger;
an inductor; and
a thermally conductive adhesive disposed upon a surface of the inductor and bonded to the heat exchanger to transfer heat from the inductor to the heat exchanger.

15. A method for manufacturing an inductive assembly, the method comprising:
providing an inductor; and
adhering a thermally conductive adhesive upon a surface of the inductor.

16. The method of claim 15 further comprising adhering the inductor to a heat exchanger with the thermally conductive adhesive.

17. The method of claim 15 further comprising assembling the inductor to a heat exchanger without any mechanical fasteners.

18. The method of claim 15 further comprising steps of:
providing a frame with a locating member; and
installing an inductive coil to the locating member.

19. The method of claim 18 further comprising molding a thermally conductive coating over the inductive coil and at least a portion of the frame.

20. The method of claim 19 wherein the thermally conductive coating provides the surface with the thermally conductive adhesive adhered thereupon.
